(19) United States
(12) Patent Application Publication
(10) Pub. No.: US 2003/0121481 A1
(43) Pub. Date: Jul. 3, 2003

(54) Fuel system

(76) Inventors: Peter Jeremy Dodd, Bucks (GB); Michael Ian Duckels, Basingstoke (GB); Alan Stockwell, Buckinghamshire (GB)

Correspondence Address: SCHWEGMAN, LUNDBERG, WOESSNER & KLUTH, P.A., P.O. BOX 2938, MINNEAPOLIS, MN, 55402, US

(21) Appl. No.: 10/285,302

(22) Filed: Oct. 31, 2002

Related U.S. Application Data
(63) Continuation of application No. PCT/GB01/01937, filed on May 3, 2001.

(30) Foreign Application Priority Data
May 3, 2000 (GB) 0010677.3
Mar. 7, 2001 (GB) 0105621.7

(51) Int. Cl. F02B 43/08

(52) U.S. Cl. 123/3

(57) ABSTRACT

A system of fuel use and fuel production comprising a vehicle, a source of liquid fuel, particularly methanol or a methanol/water mixture, means such as a methanol reformer for releasing hydrogen and carbon dioxide from the fuel, an engine such as an internal combustion engine or a fuel cell which is powered by the released hydrogen and means on the vehicle to store the released carbon dioxide. By converting the fuel into hydrogen and carbon dioxide and by providing a store for carbon dioxide on the vehicle, the present invention allows the carbon dioxide produced in the process of powering the vehicle to be collected and stored for later use in fuel production. Fuel production means are also provided.

The present invention relates to the collection of carbon dioxide, in particular to the collection and storage of carbon dioxide for subsequent use in a system of fuel production.

More particularly, the present invention relates to the collection and storage of carbon dioxide using means located on a vehicle. The present invention also aims to reduce vehicle pollution, particularly the emission of greenhouse gases such as carbon dioxide, and also to reduce the dependance on fossil fuels as a source of energy. Particular embodiments of the invention aim to provide vehicles which make efficient use of energy, including renewable energy, and which produce little or no pollution.

For many years conventional vehicles have been powered by engines which combust petrol or diesel fuel and which exhaust the waste products of this combustion into the atmosphere. In more recent years however, due to pressure to use alternative fuels and/or reduce vehicle pollution, alternative methods of powering vehicles have been developed.

One known alternative system for powering a vehicle utilises hydrogen as a fuel. The hydrogen is stored on the vehicle, say in pressurized tanks, and is combusted in some form of engine, for example a hydrogen powered fuel cell coupled to an electric motor. Such systems produce low levels of pollutants but have the disadvantage that, since, if the gaseous hydrogen fuel is used, the means required to store the hydrogen tend to be heavy and bulky. Furthermore, gaseous hydrogen has a low energy density. Hydrogen can of course be liquefied and stored on the vehicle in liquid form, however the process of liquefaction can be costly. There are also safety risks associated with the storage of hydrogen due to its potentially explosive nature.

Other alternative systems for powering vehicles use liquid fuels such as methanol. Such systems may, for example, combust methanol in an internal combustion engine and exhaust the products of combustion into the atmosphere. A fuel system of this type is described in co-pending United Kingdom patent application number GB 0010677.3 by the same applicants.

In the fuel system of the above co-pending application a liquid fuel, preferably methanol, is combusted in an engine of a vehicle. Advantageously, this system further includes means to produce liquid fuel. The fuel is produced by reacting hydrogen and carbon dioxide, the hydrogen being obtained by electrolysis of water and the carbon dioxide being collected from the atmosphere using means located on the vehicle.

The above system of fuel use and fuel production however has certain disadvantages. In particular, the collection of carbon dioxide from the atmosphere does not necessarily guarantee a reliable supply of carbon dioxide for fuel production.

It would of course be possible to use commercially available carbon dioxide for the production of fuel however this would add to the costs involved in operating the system.

What is needed therefore is a cost effective system of fuel use and fuel production in which a more reliable supply of carbon dioxide can be provided.

Accordingly, from one aspect, the present invention provides a vehicle including a source of liquid fuel, means for releasing hydrogen and carbon dioxide from the fuel, an engine powered by the released hydrogen and means on the vehicle to store the released carbon dioxide for use in subsequent fuel production.

By converting the fuel into hydrogen and carbon dioxide and by providing a store for carbon dioxide on the vehicle, the present invention allows the carbon dioxide produced in the process of powering the vehicle to be collected and stored for later use in fuel production.

The term “engine” used herein should be taken in its broadest sense to mean a device capable of obtaining power from a fuel. The engine of the present invention is therefore not necessarily limited to a single component, say in which fuel is burnt, but may comprise a series of components for example a device for generating electricity from a fuel and a device which does mechanical work powered by this electricity.

The released hydrogen provides a clean and efficient source of energy whilst the use of a liquid fuel, such as methanol or a methanol/water mixture, provides the convenience of storing energy in the form of a liquid, say, in a similar manner to the storage of fuel on conventional petrol or diesel powered vehicles.

Preferably, the means for releasing hydrogen and carbon from the fuel comprises a reactor in which the fuel is reacted with water to produce hydrogen and carbon dioxide.

One suitable reactor is a reformer such as a steam reformer. In a reformer water is reacted with the fuel under pressure and in the presence of one or more catalysts to produce hydrogen and carbon dioxide. The reformer may be supplied with a supply of fuel and a supply of water or alternatively the reformer may be supplied with a fuel/water mixture. This latter alternative has the advantage of allowing fuel and water to be stored in the same container thus providing space and cost savings. The reaction in a steam reformer requires heat therefore preferably the reactor is provided with a heat supply. Since the engine of the vehicle will produce heat during consumption of hydrogen it is preferred that this heat is used to power the reformer. This spare energy is therefore not wasted but instead is kept within the system and used to do useful work.

The preferred fuel for use in the present invention is methanol or a methanol/water mixture therefore the reformer preferably comprises a methanol reformer.

In an alternate embodiment, the reformer may comprise an auto-thermal reformer. In an auto-thermal reformer the need to heat the reactants is addressed by burning some of the fuel in the presence of oxygen obtained, for example, from the air. It is again preferred that the auto-thermal reformer is capable of producing hydrogen from methanol.

The reactor of the present invention releases hydrogen and carbon dioxide from the fuel so means are provided to separate these components so that the carbon dioxide can be stored and the hydrogen can be consumed by the vehicle's engine. The present invention therefore includes a separator for separating the hydrogen and carbon dioxide produced by the reactor.

The separator may take any suitable form and suitable devices are known in the art.

The reactor will produce a gaseous mixture of hydrogen and carbon dioxide (as well as some impurities), as is the case when the reactor comprises a steam reformer, therefore the separator is preferably capable of separating a gaseous mixture of hydrogen and carbon dioxide.

Whilst it is advantageous to recycle as much carbon dioxide as possible, and hence obtain as much carbon dioxide for fuel production as possible, it is not necessarily a requirement of the invention to recycle all of the carbon dioxide released from the fuel and thus an amount of carbon dioxide may be fed to the vehicle's engine together with hydrogen. For example, recycling as little as 20 to 50 percent of the carbon dioxide may still provide sufficient benefits to make the system commercially viable. It is of course preferred that a large proportion, say 70-80 percent or more, of carbon dioxide produced by the reactor is collected and stored for subsequent fuel production. Most preferably, all or substantially all of the carbon dioxide is recycled.

As stated above, there are many known technologies capable of separating a mixture of hydrogen and carbon dioxide. It may be the case that two or more such methods are combined to increase the proportion of carbon dioxide that is removed from the mixture of gases produced by the reactor. Thus the mixture of hydrogen and carbon dioxide produced by the reactor may pass through a series of devices each contributing to the separation of hydrogen and carbon dioxide.

One suitable type of separator envisaged by the present invention utilises a selectively permeable membrane. In such a device, for example, a gaseous mixture is fed under pressure over a selectively permeable membrane. The properties of the membrane, in particular the degree of permeability, can be selected dependant on which gases it is desired to separate.

Devices of this type are well suited for carbon dioxide collection in accordance with the invention since, compared to some known carbon dioxide extraction devices, they can be manufactured to be small, light weight, and safe to use.

Selectively permeable membrane separators generally comprise an outer elongate casing inside which a selectively permeable membrane is housed. The membrane itself preferably comprises a bundle of hollow spun fibres which generally lie along the length of the outer casing. The source gas is introduced into the interiors of the hollow fibres at one end and the relatively less permeable gases exit from the other end. The relatively more permeable gases permeate through the hollow fibres and are vented from an intermediate outlet.

In one preferred form, a variation of this selective membrane system is used which includes a closed liquid circuit containing a carrier liquid which can absorb carbon dioxide. At least a part of this carrier liquid circuit is in contact with one side of the selectively permeable membrane and the source gas is in contact with the other side of the selectively permeable membrane. The membrane is impermeable to the carrier liquid so the liquid circuit is maintained but is permeable to carbon dioxide from the source gas. In this way, carbon dioxide is separated from the source gas and is carried by the carrier liquid in the circuit.

The liquid circuit preferably includes means, such as a pump, to provide a continuous flow of carrier liquid around the circuit. As this liquid passes the selective membrane, carbon dioxide is collected from the source gas stream and the amount of carbon dioxide in the carrier liquid increases. The liquid continues to flow through the circuit to a point where the carbon dioxide is removed.

Removal of the carbon dioxide may be carried out by any suitable means but is preferably done by heating the carrier liquid at the point of removal so that gaseous carbon dioxide is evolved. The heat from the vehicle's engine may be used for this purpose.

Once the carrier liquid has passed the point of carbon dioxide removal it is then ready to pass the selectively permeable membrane again thereby completing its circuit.

The carrier liquid may take any suitable form, such as a known organic carbon dioxide carrier. Preferably, the carrier liquid comprises ethanolamine or an aqueous solution of ethanolamine. These liquids provide good reversible absorption of carbon dioxide and are known to be used in the commercial extraction of carbon dioxide. Sodium hydroxide and potassium hydroxide may also be suitable, however, the absorption of carbon dioxide may be less readily reversible.

Alternatively, separation may be achieved using palladium or palladium-silver membranes as in known devices which are well established in the field of hydrogen extraction.

As an alternative or in addition to membrane separation, separation may be done by adsorption. For example, so called amine stripping devices which adsorb gaseous carbon dioxide are known. It is again preferred when using this type of device that the heat produced by the vehicle's engine is used to drive collected carbon dioxide out of solution for storage. In these devices gaseous carbon dioxide is absorbed, say in a solution of ethanolamine, and can be subsequently driven out of solution by applying heat. In this way carbon dioxide can be separated from a mixture of gases. If such devices are used in the present invention, preferably the heat used to drive carbon dioxide out of solution would be the heat produced by the vehicle's engine. Other forms of membrane separation or/and adsorption separation may also be suitable.

A further type of separator which may be suitable for use in accordance with the present invention provides means to cool a gaseous mixture of hydrogen and carbon dioxide to a point where the carbon dioxide liquefies but the hydrogen remains gaseous thereby allowing the two components to be separated.

The cooling of the gaseous mixture of gases may be achieved by any suitable means but is preferably done by refrigeration.

One form of refrigeration which may be suitable provides a cooling effect caused by a reversible endothermic reaction. One refrigerator of this type is an ammonia absorption refrigerator. In this device, ammonia is dissolved in water in an endothermic reaction to provide a cooling effect. The solution produced as a result of dissolving ammonia in water is subsequently heated to drive the ammonia out of the solution and then cooled so that the process can be repeated in a cyclic manner to achieve refrigeration.

The carbon dioxide may for example be liquefied at a temperature of approximately 30° C. and at a pressure of approximately 84 bar. Thus liquefaction of carbon dioxide may be done through a combination of cooling and applied pressure. Means may therefore be provided to achieve the desired pressure, such as by providing a compressor.

It will be seen that the process of refrigeration requires energy and it is preferred that this process is powered by the spare heat produced by the vehicle's engine. For example, if the separator uses an ammonia absorption refrigerator it would be preferable to drive the ammonia out of solution using the heat produced by the vehicle's engine. As with the reactor, by powering the separator using this spare heat the efficiency of the system is improved.

It is likely that a number of different separation techniques will need to be combined to achieve efficient separation of carbon dioxide and hydrogen. For example, initially the gases produced by the reactor may undergo permeable membrane/solvent extraction subsequently followed by refrigeration and compression. The technique used at each stage of the separation process being chosen to take into account the levels of carbon dioxide and hydrogen, the pressure and temperature of the gas mixture and so on.

Once the hydrogen and carbon dioxide produced by the reactor have been separated, the hydrogen may be supplied to the vehicle's engine and the carbon dioxide may be stored for later use in the production of fuel.

The means for storing the carbon dioxide may take any suitable form. For example, if the carbon dioxide is stored in a gaseous state then pressure gas cylinders could be provided. The collected carbon dioxide is however preferably stored as a liquid to minimise the amount of space required for storage. Liquefaction of the carbon dioxide may be achieved by any suitable means say by using a compressor. It may be the case, as mentioned above, that the carbon dioxide is already liquefied as a result of the separation process.

The collected carbon dioxide may be stored on the vehicle in any suitable means, however, there will be circumstances where a storage device for carbon dioxide will be required in close proximity to a storage device for fuel. Whilst a separate storage device may be provided for each of these compounds, for example a fuel tank for methanol and a separate tank for collected carbon dioxide, it may be desirable to provide a storage system for multiple liquids and one such storage device is provided by the present invention.

Most liquid containers are intended to only store a single liquid so if it is desired to store multiple liquids then multiple containers are required. In addition, most liquid containers comprise a rigid shell which defines a void of a fixed volume so that when the container is empty or partially empty a portion of the void is unused and is, in effect, wasted space. Since it is often the case that space is a premium on a vehicle, the present invention aims to maximise the available space by providing a single storage means capable of storing two or more liquids wherein the space required for storing one or more of the liquids is provided by the void left by removal of one or more of the other liquids. This efficient use of space also allows storage containers to be produced which are cheaper, lighter and require less material.

Therefore, according to another aspect, the present invention provides storage means comprising an outer container which defines a fixed volume; one or more flexible bladders located within the container each of which defines a variable volume; and means to introduce liquids into and remove liquids from the various volumes defined by the outer container and the one or more flexible bladders.

Suitable conduits are provided in fluid communication with the interior of the container as well as the interior of each bladder to allow liquids to be added to or removed from the various spaces defined.

Preferably the, or each, bladder is capable of entirely filling the void defined by the outer container when the bladder is fully expanded. This allows for the total replacement of one liquid by another liquid and allows the total volume of the void to be used to its full extent to contain a single liquid. It is however also envisaged that bladders with maximum volumes of less than the total of volume of the outer container may be provided.

The outer container may be made from any suitable material of sufficient strength. Such materials include plastic composites, carbon composites or metals. One particularly suitable material is Kevlar RTM which is strong, light and easily moulded to the desired shape. The outer container is preferably of sufficient strength to allow the contents of the storage device to be pressurised. Preferably the storage device is capable of containing liquid carbon dioxide and liquid methanol.

There are also situations where it would be preferable to construct the outer container from mild steel as with conventional petrol/diesel fuel tanks. This will of course be the case if an existing tank is converted to a storage means in accordance with the present invention.

The inner bladder or bladders may be made from any material that provides a sufficient degree of flexibility, and therefore allows the bladder or bladders to collapse as they are emptied and expand as they are filled. The use of a flexible impervious plastic is particularly preferable. One suitable material may, for example, be similar to that used for the bladders provided in wine boxes.

In addition to or as an alternative to the bladders being flexible, it is envisaged that an elastic material could be used. This would allow the bladder or bladders to expand and contract like balloons during filling and emptying.

If multiple bladders are provided within the outer container then these bladders may be either concentric, i.e. where one bladder is entirely contained within another bladder, or each bladder may be independent and separated from each other bladder within the container. A combination of concentric and separate bladders is also envisaged.

Preferably, the container is not completely filled with fuel but instead a space is provided at the top of the container. This space allows the contents of the container to expand if an increase in temperature occurs, thereby reducing the possibility of the container rupturing and releasing its contents. The size of the space depends on the liquids stored and the likely range of operating temperatures.

It can be seen that the storage means is particularly suited to store fuel prior to it being used to do useful work and to store the carbon dioxide collected so that it can subsequently be used as a feedstock for the production of further fuel. It can also be seen that the amount of fuel consumed in the process of doing this useful work is in proportion to the amount of carbon dioxide collected in this process. The storage means therefore may contain a substantially constant volume and can therefore store fuel and collected carbon dioxide in a single compact space.

A further aspect of the invention provides a vehicle including a fuel storage means having two chambers separated by at least one flexible membrane such that each chamber has a variable volume with a reduction in volume of one chamber resulting in an increase in the volume of the other chamber, one chamber providing a store of fuel and the other chamber receiving carbon dioxide during operation of the vehicle which can be used to produce further quantities of fuel.

From still another aspect, the present invention provides a system or method comprising the storage of fuel within a flexible bladder, the subsequent consumption of the fuel to do useful work, the containment of this bladder within an outer container, the storage of-an intermediate compound within the space defined between the flexible bladder and the outer container, and the use of this intermediate compound in subsequent fuel production.

One advantage of this storage means when used to store liquid carbon dioxide and fuel is that the potentially more dangerous fuel can be stored in the internal bladder and surrounded by harmless liquid carbon dioxide. In the event that the containers are punctured, the presence of carbon dioxide can help to retard combustion of the fuel and assist in preventing fire.

The vehicle of the present invention may possess any suitable engine which can produce power from the hydrogen released from the fuel.

One suitable engine is a hydrogen powered fuel cell in combination with an electric motor. The fuel cell may be a proton exchange membrane fuel cell, a solid oxide fuel cell or any other type of fuel cell which can produce electricity to power the motor to propel the vehicle. The fuel cell may also power other systems in the vehicle such as heating, air conditioning and so on if required.

If the vehicle is provided with a fuel cell, in some circumstances it may be preferable to process the hydrogen supplied to the fuel cell to remove any trace carbon monoxide since this may effect the performance of some types of fuel, such as proton exchange membrane fuel cells. The trace carbon monoxide may be removed from the hydrogen supply using, for example, a catalytic oxidiser which converts carbon monoxide into carbon dioxide.

As mentioned above, the heat produced by the vehicle's engine can be usefully used to power certain systems of the present invention. In particular, to power the reactor which produces hydrogen and carbon dioxide and the separator which separates these two components. The type of engine chosen for use in the present invention preferably produces sufficient heat to power the various systems of the invention. In this regard, solid oxide fuel cells and high temperature proton exchange membrane fuel cells may be particularly suitable. The heat produced by the vehicle's engine may be augmented by heat produced from combustion of the liquid fuel, or the hydrogen rich stream, in a suitable combustion device.

An alternative type of engine suitable for use in the present invention is an internal combustion engine fuelled by hydrogen. Such an engine may be functionally similar to say a conventional petrol internal combustion engine in that combustion of fuel, in this case hydrogen is used to drive a set of pistons which drive a crank shaft and so on.

The energy density of gaseous hydrogen is relatively low say when compared to liquid petrol, so there may be a need to provide the engine with a direct supply of the liquid fuel in addition to the supply of gaseous hydrogen. This liquid fuel may then be combusted in the engine to provide extra power when needed or to start the engine in cold conditions. Thus the internal combustion engine may be capable of combusting both gaseous hydrogen and a liquid fuel such as methanol or a methanol/water mixture. Means may therefore be required to inject gaseous hydrogen and liquid fuel into a combustion chamber within the engine. Such means may comprise a fuel injector for gaseous hydrogen and a fuel injector for liquid fuel. Alternatively, fuel injectors may be provided which are capable of injecting both gaseous hydrogen and liquid fuel. The injection of hydrogen and/or liquid fuel would in these circumstances most likely be controlled by an engine management system which would monitor the operating conditions of the engine and make adjustments, such as altering the supply of fuel, accordingly. Engine management systems of this type are well known in the art. There may even be circumstances, say at peak demand for power, when the vehicle's engine is solely or at least substantially powered by the liquid fuel.

The present invention may therefore provide a vehicle including a source of liquid fuel, means to release hydrogen and carbon dioxide from the liquid fuel, means to recycle the released carbon dioxide for subsequent fuel production, wherein the vehicle has an engine which is capable of being powered by the released hydrogen and directly by the liquid fuel.

Preferably the liquid fuel is methanol or a methanol/water mixture, the liquid fuel being used directly in the vehicle's engine when more power is required or to start the engine in cold conditions.

The present invention extends to a system which includes fuel production means which may, for example, be located at the home of the owner of the vehicle or may comprise a commercial operation capable of producing fuel for a number of vehicles. The invention is not however intended to be limited by the location of the fuel production means which may in fact be located on the vehicle itself as will be described in more detail below.

The fuel production means preferably produces fuel using hydrogen and carbon dioxide. For example methanol synthesizers are known in the art and typically react carbon dioxide and hydrogen under pressure and in the presence of one or more catalysts. More than one type of catalyst may be present in such a synthesiser, for example in a series of catalyst beds, in order to convert any initial reaction products produced by the reaction of hydrogen and carbon dioxide into the desired fuel.

As can be seen, in order to produce fuel in this way a reliable source of hydrogen and carbon dioxide must be maintained.

By providing means located on the vehicle to store carbon dioxide which is released during the process of fuel use allows the carbon dioxide to be recycled and used as a feedstock for fuel production.

The hydrogen required may come from any suitable source but preferably is produced by electrolysis, particularly electrolysis of water to produce hydrogen and oxygen. One suitable electrolyser is a proton exchange membrane electrolyser or a reversible fuel cell.

The electricity required by the electrolyser may be obtained from any suitable source, for example from the mains grid or from a source of renewable energy such as solar or wind power.

The water required by the electrolyser may be obtained from any suitable source, for example mains water supply connected to the electrolyser via a suitable de-ioniser. Commercially available water electrolysis units often include a de-ioniser so that they are suitable for use with mains water.

It will be seen that when an electrolyser is used in fuel production, oxygen is produced as a byproduct. It is of course preferred that this oxygen is not wasted but is instead made use of, for example as a fuel or a chemical feedstock.

Preferably, the fuel production means is provided with a storage device which can store the manufactured fuel until it needs to be used. The fuel production means also preferably has means to store the carbon dioxide collected on a vehicle prior to being used in fuel production. Preferably, the fuel production means includes a device capable of storing both collected carbon dioxide and produced fuel. The storage device may therefore be constructed in the same way as the vehicle storage device described above, i.e. with compartments of varying volumes for containing different liquids.

By recycling carbon dioxide, the system of fuel use and fuel production of the present invention provides a continuous circuit of carbon. That is to say throughout the cycle of fuel production, fuel storage and fuel use, a substantial amount of carbon present in the system is maintained and is not released to atmosphere, either in the form of carbon dioxide or carbon monoxide. Thus energy is added to the carbon circuit, say in the form of hydrogen, to produce a fuel and removed from the circuit in the form of hydrogen when needed to do useful work. The carbon dioxide released in this process is collected and passed back around the circuit.

It will be apparent that when the system of the present invention is first used it must initially be primed with a carbon containing compound. This initial source of carbon may for example be commercially available carbon dioxide or may be carbon dioxide collected from the atmosphere. It is, however, preferred that the means of fuel production includes a priming reactor which can produce carbon, say in the form of carbon dioxide or carbon monoxide, which is then fed to the fuel production means. The priming reactor may be similar to or the same as the reactor located on the vehicle. The priming reactor is preferably supplied with a carbon containing compound, such as a hydrocarbon, which is reacted with water to produce hydrogen and carbon dioxide which are then fed to the fuel synthesizer The carbon containing compound supplied to the priming reactor may take any suitable form. This initial source of carbon may be obtained from commercially available carbon dioxide or carbon dioxide collected from the atmosphere. Alternatively, it may be from a source of carbon containing fuel such as methanol, say produced from a fossil fuel such as natural gas. Renewable biomethanol may also be used. Other fuels such as petrol and diesel may also be suitable.

In a particularly preferred embodiment which is well suited for fuel production in a domestic setting, methane in the form of natural gas is used as the initial source of carbon and is reacted with water in, say, a methane steam reformer to produce carbon dioxide and hydrogen which can then be fed to a fuel synthesizer for production of fuel.

As with the reactor located on the vehicle, the priming reactor may alternatively be an auto-thermal reformer as described above.

It is preferred that the system of fuel use and fuel production forms a closed carbon circuit with substantially all of the carbon dioxide released during fuel use being recycled and used for fuel production. In such a system, once sufficient carbon containing compound has been reacted in the priming reactor and sufficient carbon has been introduced to the system, it may be the case that the priming reactor is not required after this point since substantially no carbon dioxide is released from the carbon circuit. However, if not all of the carbon dioxide is recycled, the priming reactor may subsequently be required to top-up the system with additional carbon.

The present invention may therefore provide a system of fuel use and fuel production comprising a vehicle provided with a source of liquid fuel which is used to power the vehicle, means to recycle carbon dioxide produced in the process of fuel consumption, fuel production means to produce further fuel using the recycled carbon dioxide and means to top-up the system with carbon from an external source.

Preferably the external source of carbon is methane preferably in the form of natural gas. Alternatively, carbon dioxide from the atmosphere may be used or the source of carbon may come from a carbon containing fuel such as methanol. If methanol is used, this may be produced from a fossil fuel such as natural gas or may be renewable biomethanol. Other fuels such as petrol and diesel may also be suitable.

As an alternative to using the priming reactor to top-up the carbon in the system, commercially available carbon dioxide may be used instead.

It is also envisaged that the vehicle may be provided with means to extract carbon dioxide from the atmosphere. Such a system is described in co-pending UK application No. GB 0010677.3 by the same applicants. The extracted atmospheric carbon dioxide can then be used as a source of carbon to top-up the carbon circuit. Preferably, collection of atmospheric carbon dioxide is done using a carbon dioxide collector mounted on the vehicle and exposed to a flow of atmospheric gases as the vehicle progresses. In this way, the collector is exposed to an increased amount of carbon dioxide thereby alleviating problems due to the low concentration of carbon dioxide present in the atmosphere.

One suitable atmospheric carbon dioxide collector comprises a permeable membrane device. In this device, atmospheric gases, including carbon dioxide, are fed under pressure over a selectively permeable membrane. The relatively less permeable gases do not pass through this membrane and these residual gases are then collected or vented from the device. The relatively more permeable gases permeate through the membrane and are thereby separated from the source gas. A membrane can therefore be chosen of a permeability to separate carbon dioxide from atmospheric gases so that it can be stored to subsequently supply the fuel system with carbon.

It may also be possible to extract carbon dioxide from the exhaust gases of the vehicle's engine since, if the system is not capable of recycling all of the carbon dioxide, an amount of carbon dioxide may be present in the hydrogen supply to the engine and thus in the exhaust gases produced by the engine. It is therefore envisaged that a carbon dioxide collector may be used to collect carbon dioxide from the exhaust gases produced by the engine and located say in the exhaust pipe of the vehicle. Such a carbon dioxide collector may comprise a device as described for atmospheric carbon dioxide collection and may be provided as an alternative to or in addition to an atmospheric carbon dioxide collector.

The fuel production means of the present invention is well suited to small scale use and may be located in a domestic setting. Fuel can therefore be produced at home, say during periods when the supply of electricity is inexpensive, such as at night, or when there is an excess of electrical supply, as may occur if the household uses renewable sources of electricity such as solar or wind power. The fuel produced can then be stored at home until required.

The present invention may be applied to many types of vehicle, for example buses, trains, planes, boats, and so on, and is well suited for application in cars. A homeowners car can therefore be refuelled with fuel manufactured at home and at the same time collected carbon dioxide can be off-loaded from the car and supplied to a domestic fuel production unit for manufacture of further fuel.

Alternatively, the fuel production means may comprise a commercial operation, say similar to a conventional petrol/diesel station, at which vehicles can stop to refuel and to off-load carbon dioxide.

The fuel production means may even be located on the vehicle itself. For example, an electrolyser could be located on the vehicle to produce hydrogen from water which is then reacted with recycled carbon dioxide to produce a liquid fuel such as methanol, the methanol being split into hydrogen and carbon dioxide so that the hydrogen can be used to power the vehicle's engine and the carbon dioxide can be recycled. Thus the only external inputs into the system may be electricity and water and perhaps a top-up of carbon, as described above, if required.

The preferred form of fuel is methanol or a methanol/water mixture although other fuels may be suitable, such as ethanol, diesel, petrol, ammonia, dimethyl ether, provided that hydrogen and carbon dioxide can be released from the fuel. It should be understood that the type of fuel used in accordance with the present invention is not critical provided that hydrogen and carbon dioxide can be released from the fuel so that the hydrogen can be used to do useful work and the carbon dioxide can be recycled.

The present invention has many benefits over more conventional fuel production and fuel use systems which include, amongst other things, the flexibility of the means of fuel production, the flexibility and safety of the means of fuel storage and fuel use and environmental benefits. In addition, because of the provision of storage means there are few restrictions to the timing of the various processes, that is, fuel can be produced and consumed as and when required.

A further aspect of the invention therefore provides a method for operating a vehicle in which hydrogen released from a fuel is used to power the vehicle, and carbon dioxide released from the fuel is stored on the vehicle, wherein the stored carbon dioxide is used in production of further fuel.

Accordingly, a still further aspect of the invention therefore provides a vehicle operating system comprising at least one vehicle and means to produce is fuel for operating said vehicle, the vehicle including means to store said fuel, means to release carbon dioxide and hydrogen from said fuel, means to power the vehicle using the released hydrogen and means on the vehicle to store the released carbon dioxide, wherein said fuel production means produces further fuel using said stored carbon dioxide.

The present invention will now be described, by way of example only, with reference to the accompanying drawings in which:

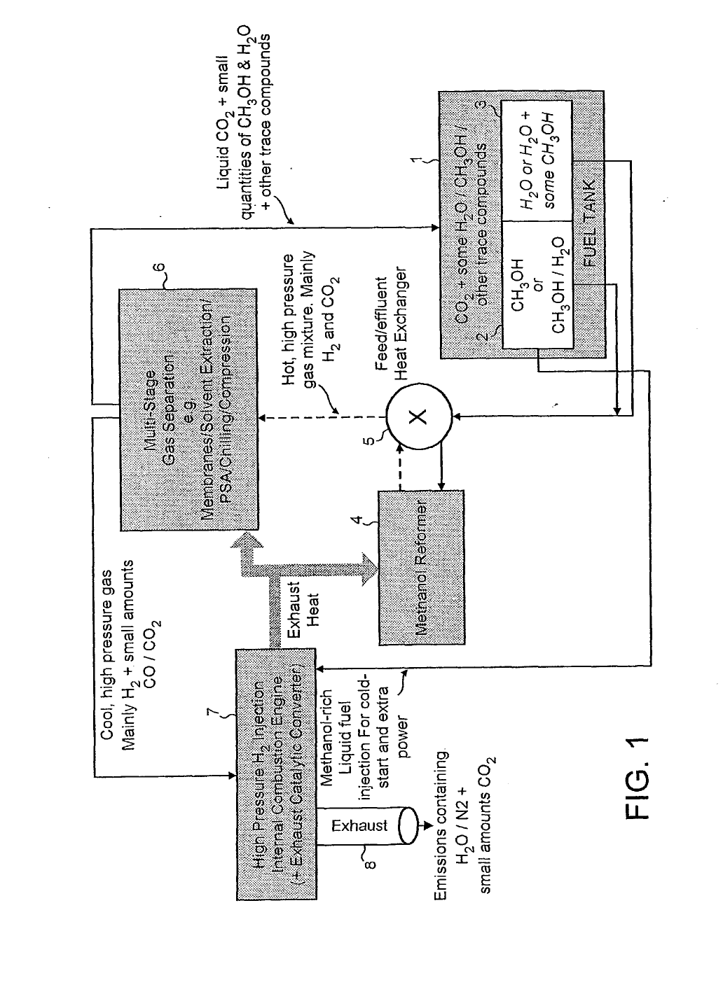

FIG. 1 illustrates in schematic form a vehicle according to one aspect of the present invention shown with a hydrogen internal combustion engine;

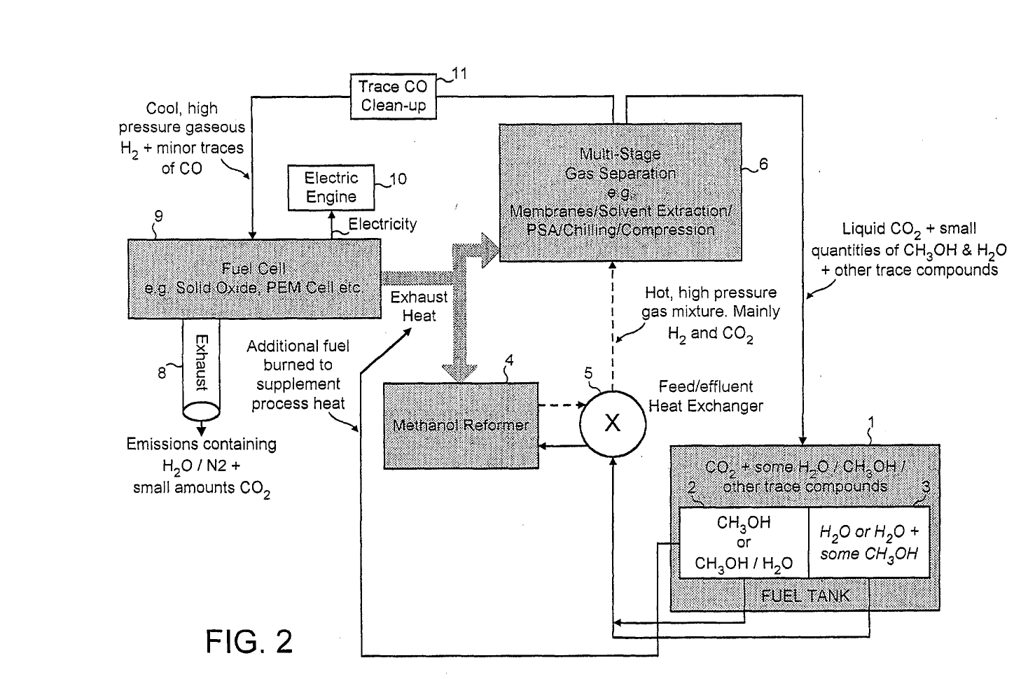

FIG. 2 illustrates in schematic form a vehicle according to one aspect of the present invention shown with a hydrogen fuel cell;

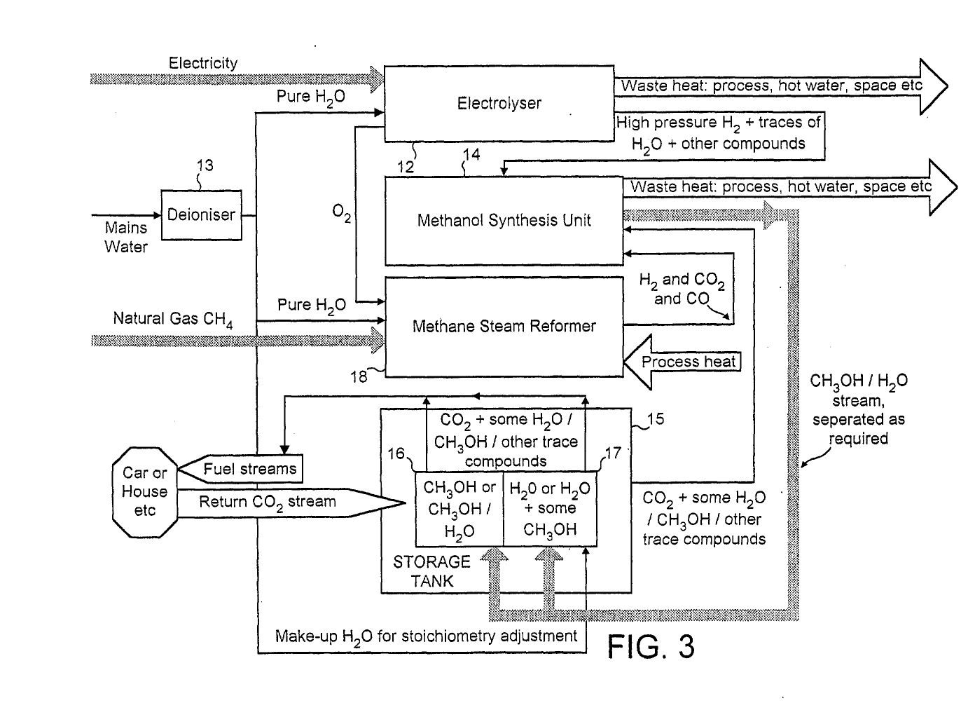

FIG. 3 illustrates one form of fuel production unit according to the present invention;

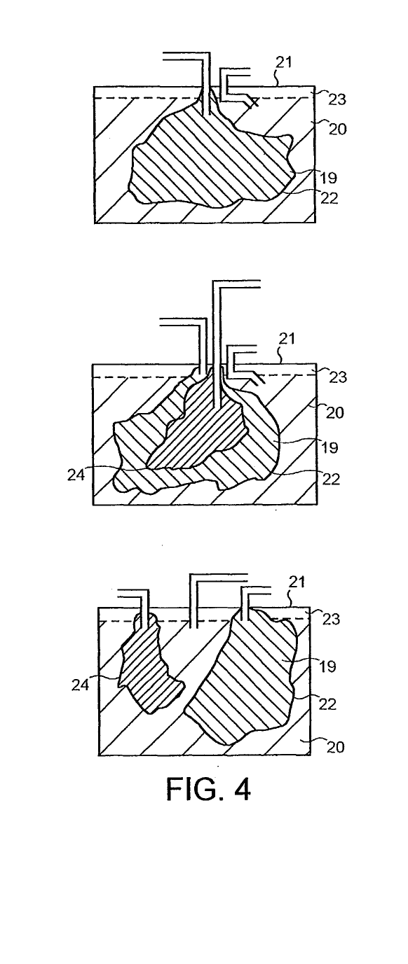

FIG. 4 illustrates in schematic form storage means in accordance with the invention;

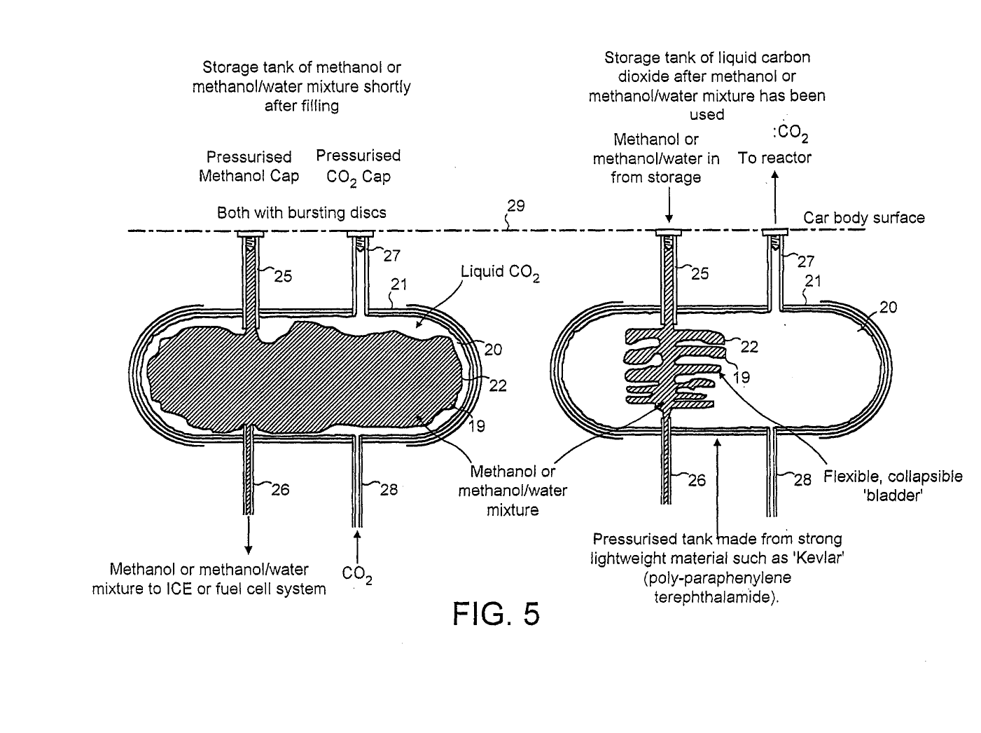

FIG. 5 illustrates in schematic form storage means in accordance with the invention located on a vehicle shortly after filling with methanol and also after most of the methanol has been consumed.

FIG. 1 shows a fuel system for a vehicle according to one embodiment of the present invention. The vehicle is provided with a source of liquid fuel 2, 3 contained within a fuel tank 1. Whilst the fuel used may be pure methanol, the illustrated fuel is a mixture of methanol and water. Two separate stores 2, 3 of methanol/water fuel are shown, one which contains pure methanol or a methanol/water mixture with a relatively high proportion of methanol, and a second which contains a methanol/water mixture with a lower proportion of methanol. The store 2 which contains pure methanol or at least a high proportion of methanol is provided as a source of high energy density fuel which may be consumed directly by the engine of the vehicle, say, when more power is required. This source of high energy density fuel can also be mixed with the lower energy density fuel in store 3 prior to processing in a methanol reformer 4 to obtain the correct proportions of methanol and water dependent on the operating conditions of the vehicle. The supply of high energy liquid fuel directly to the engine and the mixing of the two fuels in stores 2 and 3 prior to reforming would be controlled by an engine management system. In the methanol reformer 4 methanol and water are reacted in the presence of catalysts to produce gaseous hydrogen and carbon dioxide. This reaction requires heat thus the methanol/water mixture may be heated in heat exchanger 5 prior to being fed to the methanol reformer 4.

Before the hydrogen can be supplied to the engine of the vehicle it must first be separated from the carbon dioxide produced by the reactor 4. The mixture of gaseous hydrogen and carbon dioxide is therefore fed to a multi-stage separator 6. The separator 6 may process the gaseous mixture of hydrogen and carbon dioxide in a series of stages. For example, initial separation may be done using membrane and/or solvent extraction techniques to remove a large proportion of the carbon dioxide from the gaseous mixture which may then be cooled and pressurised to liquefy the remaining carbon dioxide thus allowing this to be separated. The separation techniques used in separator 6 are chosen to allow as much carbon dioxide to be recycled as possible.

The vehicle's engine may take any suitable form provided it can utilise hydrogen to do useful work such as propel the vehicle and/or power any systems on the vehicle such as heating, airconditioning and so on. In FIG. 1 the engine shown is a hydrogen powered internal combustion engine 7. Hydrogen produced by the separator 6 is fed to the internal combustion engine 7 so that energy may be obtained from the hydrogen to power the vehicle.

A supply line of methanol or methanol/water mixture is provided between the fuel tank 1 and the internal combustion engine 7. This allows liquid fuel to be directly combusted within the internal combustion engine 7 since this may be required when starting the engine in cold conditions or to provide extra power if required.

FIG. 2 illustrates an alternative form of vehicle engine comprising a hydrogen powered fuel cell 9 coupled to an electric motor 10. The fuel cell 9 may be any suitable type of fuel cell, such as a solid oxide fuel cell or a proton exchange membrane fuel cell, provided that it can produce electricity from consumption of hydrogen.

The hydrogen produced by the separator 6 is in gaseous form and may contain trace amounts of carbon monoxide gas. This carbon monoxide gas, if present, can be damaging to certain types of fuel cell so it may be preferable to supply the hydrogen via means 11 which remove any trace carbon monoxide in the hydrogen supply. The means 11 to remove carbon monoxide preferably comprises a catalytic oxidiser which converts carbon monoxide into carbon dioxide.

As mentioned above, it is preferred that the exhaust heat produced by the engine of the vehicle is not wasted but is instead utilised to power certain systems of the present invention. Both the reactor 4 and the separator 6 may require an input of energy to function and can utilise the heat produced by the engine of the vehicle. By using this heat the overall efficiency of the fuel system is improved and the need for external power/heating supplies is reduced or removed.

Where the reactor 4 comprises a methanol reformer in which methanol and water are reacted to produce hydrogen and carbon dioxide gas, there is a need for the methanol to be heated before this reaction can take place. The methanol is therefore heated using the exhaust heat emitted by the engine of the vehicle. Preferably this is achieved using some form of heat exchange unit.

The separator 6 again requires energy to separate the gaseous mixture of hydrogen and carbon dioxide and it is preferred that the exhaust heat emitted by the vehicle's engine is used to power this process. One preferred form of the separator includes a refrigeration unit used to chill the gaseous mixture of hydrogen and carbon dioxide to a point where the carbon dioxide liquefies but the hydrogen remains gaseous thus allowing the two components to be separated. A preferred form of refrigeration unit provides a cooling effect caused by a reversible endothermic chemical reaction. This may be achieved, for example by dissolving ammonia in water in an endothermic reaction to provide a cooling effect and subsequently heating the solution produced to drive the ammonia out of solution so that the process can be repeated to achieve continuous refrigeration. In this process the heat from the vehicle's engine would therefore be used to drive the ammonia out of solution and thus power the separator 6.

The carbon dioxide produced by the separator 6 is collected and stored. Preferably the carbon dioxide is stored in liquid form to minimise the amount of storage space required. As illustrated schematically in FIGS. 1 and 2 the container for carbon dioxide and the container for liquid fuel preferably comprise a single storage unit 1 capable of containing multiple liquids. The storage device is arranged so that the liquid fuel is surrounded by liquid carbon dioxide. In this way, should the containers be accidentally punctured the carbon dioxide surrounding the liquid fuel can act to retard combustion of the fuel and reduce the risk of fire. Preferably the outer container comprises a rigid pressure vessel whilst the inner containers comprise flexible bladders.

As methanol/water fuel is removed from an inner bladder and used to power the vehicle the space occupied by the bladder is reduced allowing carbon dioxide collected during this process to be stored between the bladder and the outer container. This storage unit may therefore contain a substantially constant volume of liquid thus efficiently utilising the available space.

In addition to a system of fuel use for a vehicle, the present invention further provides means of fuel production. One form of fuel production means according to the present invention is illustrated in FIG. 3.

The fuel production system shown in FIG. 3 produces fuel from hydrogen and carbon dioxide. The system comprises a store 15 of carbon dioxide, means of hydrogen production 12 and a fuel synthesiser 14. Preferably the fuel synthesiser 14 is a methanol synthesiser as this is the preferred choice of fuel for use with the present invention. The store for carbon dioxide 15 contains carbon dioxide that has been offloaded from a vehicle and which has been collected during operation of the vehicle.

The means for producing hydrogen 12 preferably comprises an electrolyser, particularly a proton exchange membrane electrolyser or a reversible fuel cell, which produces hydrogen and oxygen from the electrolysis of water. The electrolyser 12 is supplied with a source of electricity which may, for example, be mains electricity. It is also envisaged however that the electrical supply to the electrolyser 12 may come from a renewable source of electricity such as from wind, wave or solar power. The electrolyser 12 is also supplied with water which may be mains water passed through a suitable deioniser 13.

The fuel synthesiser 14 reacts carbon dioxide taken from storage device 15 and hydrogen taken from the electrolyser 12 to produce liquid fuel and water. Suitable fuel synthesisers are known in the art. The liquid fuel produced is then stored in fuel tanks 16, 17 until required. Again, as with the storage device provided on the vehicle shown in FIGS. 1 and 2, the storage device for carbon dioxide 15 and the storage device for manufactured liquid fuel 16, 17 preferably form a combined storage unit with the liquid fuel surrounded by liquid carbon as described above. The fuel tanks 16 and 17 may therefore comprise flexible bladders as previously described.

It will be apparent that by providing a vehicle with a source of liquid fuel, collecting carbon dioxide released from this fuel during the process of powering the vehicle and then subsequently using this collected carbon dioxide to produce further fuel, the present invention provides a system of fuel use and fuel production in which the carbon present in the system is substantially recycled. That is to say, no significant amounts of carbon, say in the form of carbon dioxide or carbon monoxide, enter or exit the system.

It will also be apparent, however, that when the system is first used a supply of carbon, say in the form of carbon containing compounds, must be provided to initially prime the system The fuel production means therefore preferably includes means to introduce a carbon containing compound into the system of fuel production from an external source. As illustrated in FIG. 3 the means to prime the system comprises a priming reactor 18 in which water and a hydrocarbon are reacted to produce hydrogen, carbon dioxide and in certain circumstances carbon monoxide. The gases produced by the priming reactor 18 are fed to the fuel synthesiser 10 so that the process of fuel production can begin. The source of hydrocarbon supplied to the priming reactor may take any suitable form but is preferably methane which may, for example, be taken from mains natural gas. Once sufficient hydrocarbon has been reacted in the priming reactor 18 and sufficient carbon has been introduced into the system, the priming reactor 18 may no longer be required for the system to operate. The priming reactor 18 may thus be effectively redundant after this point although it may be required to top-up the system should additional carbon be required, say due to carbon being exhausted to the atmosphere as carbon dioxide or carbon monoxide. It will be apparent that the priming reactor 18 of the fuel production means may be the same as or similar to the reactor 4 provided on the vehicle.

FIG. 4 illustrates in schematic form various alternative forms of storage means in accordance with the present invention. Each of the storage means shown is capable of containing at least two liquids, in the context of the present invention these liquids will be a liquid fuel 19 and liquid carbon dioxide 20. Each storage means generally comprises an outer container 21 and a flexible bladder 22 housed within the outer container 21. The flexible bladder 22 defines two distinct storage volumes within the outer container 21.

A space 23 may be provided to allow for expansion of the liquids in the container 21 due to temperature increase thereby minimising the risk of the container rupturing and spilling its contents. Additional bladders 24 may be provided if it is desired to store, additional types of liquid.

FIG. 5 shows a storage means of the invention located on a vehicle. This figure shows the storage means both shortly after filling with liquid fuel 19 and also after most of the liquid fuel 19 has been consumed, its volume being replaced by liquid carbon dioxide 20. The conduits for filling and removing liquids from the storage means are also shown in this figure. A fuel inlet 25 extends between the storage means and the surface of the car's body and is in fluid communication with the interior of bladder 22 to allow the storage means to be filled with fuel 19 from an external source, in a manner similar to the filling of a conventional petrol fuel tank. A fuel outlet 26 is also provided in fluid communication with the interior of bladder 22. This outlet supplies fuel 19 to the reactor 4 of the present invention. A carbon dioxide outlet 27 extends between the storage means and the surface of the car's body and is in fluid communication with the volume defined between the outer container 21 and the bladder 22. This outlet 27 allows collected liquid carbon dioxide 20 to be off loaded from the car for subsequent used in fuel production. Finally, a carbon dioxide inlet 28 is provided, also in fluid communication with this volume, to allow collected carbon dioxide 20 to be stored in the storage means prior to unloading.

Although the present invention has been described with reference to preferred embodiments it will be understood by those skilled in the art that various changes in form and detail may be made without departing from the scope of the invention.

1. A vehicle including a source of liquid fuel, means for releasing hydrogen and carbon dioxide from the fuel, an engine powered by the released hydrogen and means on the vehicle to store the released carbon dioxide for use in subsequent fuel production.

2. The vehicle of claim 1 wherein the means for releasing hydrogen and carbon from the fuel comprises a reactor in which the liquid fuel is reacted with water to produce hydrogen and carbon dioxide.

3. The vehicle of claim 2 wherein the reactor is a reformer such as a steam reformer.

4. The vehicle of claim 3 wherein the reformer has a supply of liquid fuel and a supply of water or alternatively the reformer is supplied with a fuel/water mixture.

5. The vehicle of any of claims 2 to 4 wherein the reactor is provided with a heat supply.

6. The vehicle of claim 5 wherein the heat supply originates from heat produced during consumption of hydrogen by the engine of the vehicle.

7. The vehicle of any preceding claim wherein the liquid fuel is methanol or a methanol/water mixture

8. The vehicle of any of claims 3 to 7 wherein the reformer comprises an auto-thermal reformer.

9. The vehicle of claim 8 wherein the need to heat the reactants of the reformer is addressed by burning some of the liquid fuel in the presence of oxygen.

10. The vehicle of claim 9 wherein the oxygen is obtained from the air.

11. The vehicle of any of claims 8 to 10 wherein the auto-thermal reformer is capable of producing hydrogen from methanol or a methanol/water mixture.

12. The vehicle of any preceding claim wherein means are provided to separate the hydrogen and carbon dioxide released from the fuel.

13. The vehicle of claim 12 wherein the separator is capable of separating a gaseous mixture of hydrogen and carbon dioxide.

14. The vehicle of claims 12 or 13 wherein 20 to 50 percent of released carbon dioxide is separated from the gaseous mixture.

15. The vehicle of claims 12 or 13 wherein 50 to 70 percent of released carbon dioxide is separated from the gaseous mixture.

16. The vehicle of claims 12 or 13 wherein 70-80 percent or more of released carbon dioxide is separated from the gaseous mixture.

17. The vehicle of any of claims 12 to 16 wherein two or more separation devices are combined to increase the proportion of carbon dioxide that is removed from the gaseous.

18. The vehicle of claims 17 wherein the gaseous mixture of hydrogen and carbon dioxide passes through a series of devices each contributing to the separation of hydrogen and carbon dioxide.

19. The vehicle of any of claims 12 to 17 wherein a selectively permeable membrane system is used to separate the gaseous mixture.

20. The vehicle of claim 19 wherein the selective membrane system includes a closed liquid circuit containing a carrier liquid which can absorb carbon dioxide.

21. The vehicle of claim 20 wherein carbon dioxide is collected from the gaseous mixture and carried by the carrier liquid.

22. The vehicle of claim 21 wherein means are provided to remove the carbon dioxide from the carrier liquid by heating the carrier liquid at the point of removal so that gaseous carbon dioxide is evolved.

23. The vehicle of claim 22 wherein heat from the vehicle's engine is used to heat the carrier liquid to evolve carbon dioxide.

24. The vehicle of any of claims 20 to 23 wherein the carrier liquid comprises ethanolamine or an aqueous solution of ethanolamine.

25. The vehicle of any of claims 19 to 24 wherein the selectively permeable membrane system includes one or more palladium or palladium-silver membranes.

26. The vehicle of any of claims 12-25 wherein an adsorption device is used to separate the gaseous mixture, for example a amine stripping device.

27. The vehicle of claim 26 wherein heat produced by the vehicle's engine is used to power the adsorption device.

28. The vehicle of any claims 12 to 25 wherein separation means are provided to cool the gaseous mixture of hydrogen and carbon dioxide to a point where the carbon dioxide liquefies but the hydrogen remains gaseous thereby allowing the two components to be separated.

29. The vehicle of claim 28 wherein cooling of the gaseous mixture is done by refrigeration.

30. The vehicle of claim 29 wherein refrigeration is achieved by providing a cooling effect caused by a reversible endothermic reaction, for example as in an ammonia absorption refrigerator.

31. The vehicle of any of claims 28 to 30 wherein liquefaction of carbon dioxide is done through a combination of cooling and applied pressure.

32. The vehicle of any of claims 28 to 31 wherein the process of liquefaction is powered by heat produced by the vehicle's engine.

33. The vehicle of any preceding claim wherein the released carbon dioxide is stored in a gaseous state.

34. The vehicle of any of claims 1 to 32 wherein the released carbon dioxide is stored as a liquid.

35. The vehicle of claims 33 or 34 further including a storage device comprising an outer container which defines a fixed volume; one or more flexible bladders located within the container each of which defines a variable volume; and means to introduce liquids into and remove liquids from the various volumes defined by the outer container and the one or more flexible bladders.

36. The vehicle of claim 35 wherein the, or each, bladder is capable of entirely filling the void defined by the outer container when the bladder(s) is fully expanded.

37. The vehicle of claim 35 wherein the or each bladder has a maximum volume of less than the total of volume of the outer container.

38. The vehicle of any of claims 35 to 37 wherein the storage device contains liquid fuel and liquid carbon dioxide.

39. The vehicle of any preceding claim wherein the engine is a hydrogen powered fuel cell in combination with an electric motor.

40. The vehicle of claim 39 wherein the fuel cell is a proton exchange membrane fuel cell, a solid oxide fuel cell or any other type of fuel cell which can produce electricity to power the motor to propel the vehicle.

41. The vehicle of claims 39 or 40 wherein the fuel cell also powers other systems in the vehicle, such as heating, air conditioning and so on.

42. The vehicle of any of claims 39 to 41 wherein means are provided to process the hydrogen supplied to the fuel cell to remove trace carbon monoxide.

43. The vehicle of claim 42 wherein trace carbon monoxide is removed from the hydrogen supply using a catalytic oxidiser which converts carbon monoxide into carbon dioxide.

44. The vehicle of any of claims 1 to 38 wherein the engine is an internal combustion engine.

45. The vehicle of claim 44 wherein the engine has a supply of the liquid fuel in addition to the supply of gaseous hydrogen.

46. The vehicle of claim 45 wherein the engine combusts liquid fuel directly to provide extra power or to start the engine in cold conditions.

47. The vehicle of claims 45 or 46 wherein the engine includes means to inject gaseous hydrogen and liquid fuel into a combustion chamber within the engine.

48. The vehicle of any of claims 45 to 47 wherein the engine includes a fuel injector for gaseous hydrogen and a fuel injector for liquid fuel.

49. The vehicle of any of claims 45 to 47 wherein the engine includes a fuel injector capable of injecting both gaseous hydrogen and liquid fuel.

50. The vehicle of any preceding claim wherein the supply of fuel to the engine is controlled by an engine management system.

51. A vehicle including a source of liquid fuel, means to release hydrogen and carbon dioxide from the liquid fuel, means to recycle the released carbon dioxide for subsequent fuel production, wherein the vehicle has an engine which is capable of being powered by the released hydrogen and directly by the liquid fuel.

52. A system of fuel use and fuel production comprising a vehicle provided with a source of liquid fuel which is used to power the vehicle, means to recycle carbon dioxide produced in the process of fuel consumption, fuel production means to produce further fuel using the recycled carbon dioxide.

53. The system of claim 52 wherein the fuel production means produces fuel using hydrogen and carbon dioxide.

54. The system of claim 53 wherein the hydrogen required for fuel production is produced by electrolysis of water.

55. The system of claim 54 wherein electrolysis is done in a proton exchange membrane electrolyser or a reversible fuel cell.

56. The system of claims 54 or 55 wherein the electricity required for electrolysis is obtained from the mains grid or from a source of renewable energy, such as solar or wind power.

57. The system of any of claims 54 to 56 wherein the water required for electrolysis is obtained from the mains water supply.

58. The system of any of claims 51 to 57 wherein the fuel production means includes a storage device which can store manufactured fuel.

59. The system of any of claims 51 to 58 wherein the fuel production means includes a storage device which can store carbon dioxide collected on a vehicle prior to being used in fuel production.

60. The system of claim 59 wherein the fuel production means includes a device capable of storing both collected carbon dioxide and produced fuel.

61. The system of claim 60 wherein the storage device has two chambers separated by at least one flexible membrane such that each chamber has a variable volume with a reduction in volume of one chamber resulting in an increase in the volume of the other chamber, one chamber providing a store of fuel and the other chamber receiving carbon dioxide during operation of the vehicle which can be used to produce further quantities of fuel.

62. The system of any of claims 51 to 61 wherein the fuel production means include means to introduce carbon into the system from an external source which can then be used in fuel production.

63. The system of claim 62 wherein the external source of carbon comprises a carbon containing compound.

64. The system of claim 63 wherein the external source of carbon is commercially available carbon dioxide or carbon dioxide collected from the atmosphere.

65. The system of claim 63 wherein the external source of
carbon dioxide comprises methanol.

66. The system of claim 65 wherein the methanol is produced from a fossil fuel or is biomethanol.

67. The system of claim 63 wherein the external source of carbon is obtained by extracting carbon dioxide from the exhaust gases of the vehicle's engine

68. The system of claim 67 wherein a carbon dioxide collector is used to collect carbon dioxide from the exhaust gases produced by the engine and is located in the exhaust pipe of the vehicle.

69. The system of any of claims 62 to 68 wherein the means for introducing carbon into the system comprises a priming reactor which can produce carbon, say in the form of carbon dioxide or carbon monoxide, and which is used to initially prime the system with carbon.

70. The system of claim 69 wherein the priming reactor is supplied with a hydrocarbon, which is reacted with water to produce hydrogen and carbon dioxide which are then fed to a fuel synthesizer.

71. The system of claims 69 or 70 wherein the priming reactor is an auto-thermal reformer.

72. The system of any of claims 51 to 71 wherein the system operates as a substantially closed carbon circuit with substantially all of the carbon dioxide released during fuel use being recycled and used for fuel production.

73. The system of any of claims 51 to 72 wherein priming reactor is used to top-up the system with additional carbon.

74. The system of any of claims 51 to 73 wherein the fuel production means is located on the vehicle.

75. The vehicle or system of any preceding claim wherein the liquid fuel is any liquid fuel from which hydrogen and carbon dioxide can be obtained.

76. The vehicle or system of claim 75 wherein the liquid fuel is chosen from one or more of methanol, a methanol/water mixture, ethanol, diesel, petrol, ammonia, dimethyl ether.

77. A method for operating a vehicle in which hydrogen released from a fuel is used to power the vehicle, and carbon dioxide released from the fuel is stored on the vehicle, wherein the stored carbon dioxide is used in production of further fuel.

78. A vehicle operating system comprising at least one vehicle and means to produce fuel for operating said vehicle, the vehicle including means to store said fuel, means to release carbon dioxide and hydrogen from said fuel, means to power the vehicle using the released hydrogen and means on the vehicle to store the released carbon dioxide, wherein said fuel production means produces further fuel using said stored carbon dioxide.

79. A storage device comprising an outer container which defines a fixed volume; one or more flexible bladders located within the container each of which defines a variable volume; and means to introduce liquids into and remove liquids from the various volumes defined by the outer container and the one or more flexible bladders.

80. The storage device of claim 79 wherein the, or each, bladder is capable of entirely filling the void defined by the outer container when the bladder(s) is fully expanded.

81. The storage device of claim 79 wherein the or each bladder has a maximum volume of less than the total of volume of the outer container.

82. The storage device of any of claims 79 to 81 containing liquid fuel prior and liquid carbon dioxide.

83. A vehicle including a fuel storage means having two chambers separated by at least one flexible membrane such that each chamber has a variable volume with a reduction in volume of one chamber resulting in an increase in the volume of the other chamber, one chamber providing a store of fuel and the other chamber receiving carbon dioxide during operation of the vehicle which can be used to produce further quantities of fuel.

84. A system or method comprising the storage of fuel within a flexible bladder, the subsequent consumption of the fuel to do useful work, the containment of this bladder within an outer container, the storage of an intermediate compound within the space defined between the flexible bladder and the outer container, and the use of this intermediate compound in subsequent fuel production.
